(19) United States
(12) Patent Application Publication
(10) Pub. No.: US 2019/0085787 A1
(43) Pub. Date: Mar. 21, 2019

(54) CYLINDER SLEEVE FOR INTERNAL COMBUSTION ENGINES

(71) Applicants: Mahle Metal Leve S/A, Jundiai - Sp (BR); Mahle International GmbH, Stuttgart (DE)

(72) Inventors: Rafael BETTINI RABELLO, Jundiai (BR); Stefan GAISELMANN, Stuttgart (DE)

(21) Appl. No.: 16/087,643

(22) PCT Filed: May 30, 2016
(86) PCT No.: PCT/BR2016/050117

§ 371 Date: Sep. 22, 2018

(30) Foreign Application Priority Data
Mar. 22, 2016 (BR) BR102016006242-0

(51) Int. Cl. F02F 1/00; F16J 10/04; B24B 1/00; B24B 39/02; B24B 31/112

(52) U.S. Cl. CPC F02F 1/004; F16J 10/04; B24B 31/112; B24B 39/02; B24B 1/005

(57) ABSTRACT

A cylinder sleeve for an internal combustion engine may include a bore-through cylindrical body having an inner sliding surface. The inner surface may have a surface finish with a rugosity defined by a valley-and-peak structure. The rugosity of the inner surface may have a ratio between a peak density and a mean radius of curvature of peaks that is higher than 150 and lower than 400. The rugosity may also have a ratio between the mean radius of curvature of peaks and an average height of peaks that is lower than 1500.

### CROSS-REFERENCE TO RELATED APPLICATIONS

This application claims priority to International Patent Application No. PCT/BR2016/050117, filed on May 30, 2016, and Brazilian Patent Application No. BR102016006242-0 22, filed on Mar. 22, 2016, the contents of both of which are hereby incorporated by reference in their entirety.

### TECHNICAL FIELD

The present invention relates to a cylinder sleeve for use on internal combustion engines, the jacket being provided with a bored-through body comprising an inner surface exhibiting a surface finish with rugosity defined by a structure of rounded peaks and valleys, showing a reduced number of peaks per area unit of the inner surface.

### BACKGROUND

Cylinder sleeves for use on internal combustion engines are static components that compose the structure of the engine block, providing the assembly with a closed system for expanding gases and providing heat exchange of the heat generated in the combustion with water (wet cylinder sleeve) or air (dry cylinder sleeve) that circulate around it.

Among the objectives of the different jacket types, one points out the sealing of the combustion chamber, the heat exchange of the heat generated within the combustion chamber with the cooling means (water or air) and the possibility of re-using the engine block.

In operation, an internal combustion engine admits an air/fuel mixture into the cylinder, which will come into spontaneous combustion after being compressed (diesel engines) or by means of an ignition spark created within the combustion chamber during the combustion of the mixture (alcohol and/or gasoline).

The combustion of expanding gases will take place within a closed system, so that a part of the energy generated will push the engine piston downward and successively move the crankshaft, thus transforming energy into motion. Thus, cylinder sleeves act on the operation of the engine providing the system the closed condition required for the energy transforming process.

The growing demands related to internal combustion engines require continuous improvements regarding their various components and their sliding surfaces. An accurate relation between cylinder sleeves, the pistons and piston rings leads to an improvement of engine output.

Usually, cylinder sleeves for use on internal combustion engines are produced from cast iron with addition of alloy elements to improve their mechanical and thermal properties. Besides the addition of alloy elements, cast-iron jackets also need optimized sliding surfaces, which contribute for decreasing the consumption of oil and circulation of the gases, produce less particles due to the wear and enable shorter softening times and, as a result, longer useful life.

Thus, in order to achieve optimization of the sliding surface of the cylinder sleeves, there are a number of finish processes like, for example, electrochemical polishing, brushing, jetting abrasive fine powder, cutting and polishing, micro-milling, burnishing, among others.

The usually employed finishing process is burnishing, a machining method in which the tool carries out alternating and rotating movement, guaranteeing the cylindricality of the jacket and uniformity of its surface. A well done burnishing guarantees positives effects on wear of the piston wing, emission of particles, consumption of oil and on friction.

Various techniques have been developed with a view to achieving better operation conditions of cylinder sleeves by means of varied burnishing processes.

A first development is disclosed in German document DE 102006057111, belonging to the same applicant, which relates to a cylinder sleeve wherein the rugosity varies along the displacement direction of the piston inside it. More specifically, the portion adjacent to the maximum piston stroke toward the cylinder head has a region with a first rugosity and the central region of the jacket, with respect to the piston stroke, exhibits a second rugosity, and in the intermediate portion of the sliding surface of the jacket the rugosity value is higher than at the ends.

Patent document DE102009010791 discloses a cylinder sleeve provided with higher rogosity at the ends with respect to the value of rugosity in the central region. However, the process used for achieving these structures leads to the appearance of recesses with greater or lesser depth (the depth varies considerably among them), which decreases the efficacy potential of this solution as pockets of accumulation of lubricating oil.

Document WO2015/010178, belonging to the same applicant, discloses a sliding assembly comprising a cylinder sleeve and a piston ring, the inner surface of the cylinder sleeve exhibiting a central portion with rugosity lesser than that exhibited by the two limit portions of the piston displacement, whereas the piston ring exhibits a ceramic coating deposited by a PVD (physical vapor deposition), imparting to the contact surface of the sleeve great resistance to wear exerted by the ring.

Thus, one observes that there are in the prior art various technologies applied to the burnishing processes for cylinder sleeves, aiming particularly at specifications of the traditional rugosity parameters (Rpk, Rk and Rvk) along the length of displacement of the piston inside it.

However, one has not found documents that demonstrate, in addition to the importance of the traditional rugosity parameters (Rpk, Rk and Rvk), a study of additional parameters of the valley-and-peak structure comprised by the inner surface of the cylinder sleeve.

With a view to reduce the friction pressures between the inner surface of the cylinder sleeve and a sliding piston-ring/piston assembly, and to increase its hydrodynamic lift, one presents a cylinder sleeve for internal combustion engines provided with a bored-through body comprising an inner surface having surface finish with rugosity defined by a structure of rounded valley and peaks, disclosing a reduced number of peaks per area unit of the inner surface.

A first objective of the present invention is to provide a cylinder sleeve for use on internal combustion engine, provided with a bored-through cylindrical body comprising an inner contact surface with a sliding assembly, which has a surface finish with rugosity defined by a structure of rounded valleys and peaks, disclosing a reduced number of peaks per are unit of the inner surface, guaranteeing positive effects ion increasing the hydrodynamic lift and in reducing the friction pressures of the inner surface of the sleeve with respect to its sliding parts, as a piston ring assembly, with the consequent reduction in the consumption of fuel of the engine.

Particularly, the present invention has the objective of providing a cylinder sleeve comprising an inner contact surface with a sliding assembly, which exhibits a surface finish with rugosity defined by reducing parameters such as peak density (Sds) and mean radius of curvature of peaks (Ssc), with a view to reduce the friction of the inner surface of the sleeve with respect to its sliding parts, as a piston ring assembly, particularly at the piston-reversal points, and increase the hydrodynamic lift of the surface, particularly in the middle of the piston stroke, a region in which the piston and piston rings reach the highest speed.

### SUMMARY

The objectives of the present invention are achieved by means of a cylinder sleeve for internal combustion engine, provided with a bored-through cylindrical body comprising an inner sliding surface having a surface finish with rugosity defined by a structure of rounded valleys and peaks, the rugosity of the inner surface being established so that:

the ratio between the peak density (Sds) and the mean radius of curvature of peaks (Ssc) is higher than 150 and lower than 400 (150<Sds/Ssc<400);

the ratio between the mean radius of curvature of peaks (Ssc) and the average height of peaks (Spk) is lower than 1500 (Ssc/Spk<1500).

The objectives of the present invention are also achieved by means of a cylinder sleeve provided with the inner surface comprising density of peaks (Sds) ranging from 5,000 and 27,000 peaks per square millimeter (1/mm2) and the mean radius of curvature (Ssc) ranging from 86 to 105 peaks per millimeter (1/mm), with the ratios between the rugosity parameters being achieved by means of a magnetic surface-finishing process carried out after a burnishing process.

Further, the objectives of the present invention are achieved by means of a magnetic surface-finishing process for obtaining a cylinder sleeve for use on internal combustion engines, comprising the following steps:

a. arranging a magnetic pole inside the cylinder sleeve, close to an inner surface of said cylinder sleeve;

b. filling up the inside of the cylinder sleeve with a magnetizable powder;

c. creating a magnetic field inside the cylindrical sleeve;

d. wearing peaks of the internal surface by friction with the magnetizable powder.

Moreover, the objectives of the present invention are achieved by means of a magnetic surface-finishing method that uses magnetizable poweder comprising granulometry ranging from 4 to 300 micrometers, preferably from 6 to 200 micrometers, preferably from 10 to 100 micrometers, being applied after carrying out a burnishing process on the inner surface of the cylinder sleeve.

### BRIEF DESCRIPTION OF THE DRAWINGS

The present invention will now be described in greater detail with reference to an example of embodiment represented in the drawings. The figures show:

FIG. 1 shows a cross-sectional views of the sleeve with indication of the parts that constitute it;

FIG. 2 shows a graphic representation of the traditional rugosity parameters: Rpk, Rk and Rvk;

FIG. 3 shows a graphic result of the variation of the rugosity parameters Rpk, Rk and Rvk for a cylinder sleeve of the prior art with respect to the present invention;

FIG. 4 is a photograph of the rugosity topography of the inner surface of a cylinder sleeve of the prior art with respect to the present invention;

FIG. 5 is a representation of the parameters Sds and Ssc of a prior-art sleeve with respect to the present invention;

FIG. 6 shows a graphic result of the variation of the average effective friction pressure (FMEP) for a prior-art sleeve with respect to the present invention;

FIG. 7 shows a graphic result of the variation of friction for a prior-art sleeve with respect to the present invention; and

FIG. 8 is a schematic view of the cylinder sleeve of the present invention, with representation of the rugosity of its inner surface.

### DETAILED DESCRIPTION

The present invention relates to a cylinder sleeve 1 for use on an internal combustion engine, provided with a bored-through cylindrical body 2 comprising an inner contact surface 4 with at least one piston ring, the inner surface 4 exhibiting a surface finish with rugosity defined by a structure of rounded valleys and peaks, disclosing a reduced number of peaks per area unit of the inner surface 4.

As mentioned before, cylinder sleeves for use on internal combustion engines are static components that compose the structure of the engine block, providing the assembly with a system closed to the expending gases, and providing heat exchange of the heat generated in the combustion with water (wet cylinder sleeve) or air (dry cylinder sleeve) that circulate around the latter.

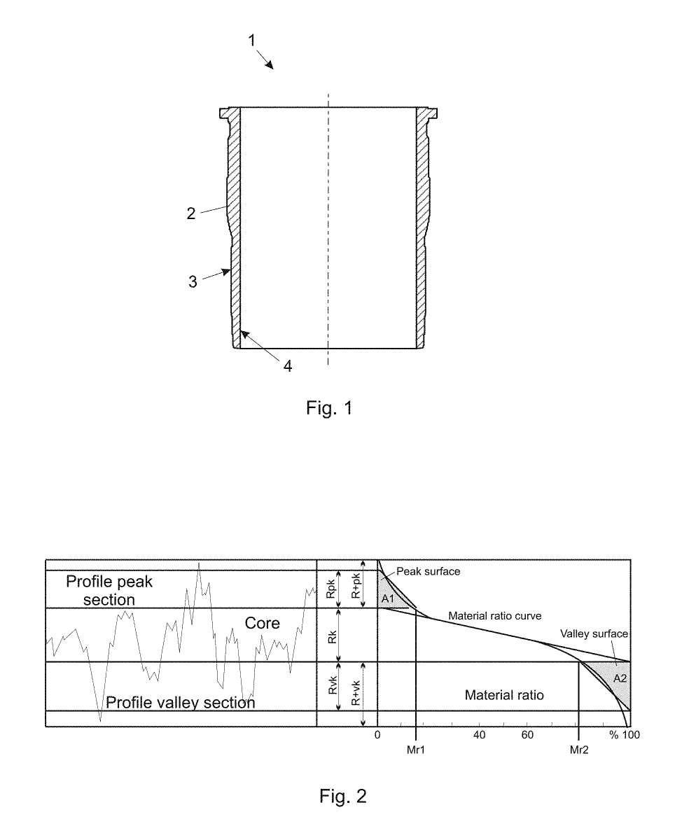

The cylinder sleeves 1 are basically provided with a tube or bore-through body, which comprises an outer contact surface 3 with a cooling fluid, be it water or air; and an inner contact surface 4 with at lest one piston ring, on which the axial sliding of a piston takes place. This constructive embodiment is observed in FIG. 1 of the present application.

Usually, cylinder sleeves 1 are produced from ferrous alloys, cast iron or steel, and may comprise other necessary or desirable materials (such as aluminum alloys) in their manufacture. Analogously, the sleeves 1 may have any necessary or desirable shape, as long as it is functional.

One of the conditions required for correct functioning of internal combustion engines is the achievement of accurate relation between the cylinder sleeves 1, the pistons and piston rings, this functioning leading to the improvement of the output of the engine. For this reason, the cylinders sleeves 1 need optimized sliding surfaces, which contribute chiefly to prolong the useful life of the engines.

In order to achieve the internal sliding surface 4 of the cylinder sleeves 1, one usually carries out surface finishing processes such as burnishing, which have the objective of removing unevenness resulting from machining, thus providing the sleeve 1 with a uniform final finish, with controlled process angles and rugosity values. Well done polishing process guarantees positive effects on wear of the piston ring, emission of particles, consumption of oil and friction.

Thus, the present invention discloses, in addition to a conventional burnishing process, a magnetic surface finishing process applied to the inner surface 4 of the sleeve 1 after the burnishing process has been carried out. This magnetic surface finishing process guarantees that the inner surface 4 will exhibit a surface finish with rugosity defined by a structure of rounded valleys and peaks, reducing the number of peaks generated from the burnishing process. With this magnetic surface finishing process, the traditional rugosity parameters Rpk, Rk and Rvk generated by the burnishing, and burnishing angles are kept, but there is a rounding of the rugosity valleys and peaks (Ssc), in addition to abrupt reduction in the peak density (Sds) on the inner surface 4.

The burnishing process applied to the inner surface 4 of the sleeve 1 of the present invention is a mechanical abrasion-machining process, which carried out a surface finish, creating rugosity defined by a structure of valleys and peaks by means of friction of an abrasive tool with the inner surface 4 of the sleeve 1. The burnishing process is carried out in at least one step or ion a number of steps, with modifications of the abrasive material an d/or granulometry of the abrasive tool, enabling greater or lesser removal of material from the inner surface 4 of the sleeve 1, with a view to achieve rugosity specification with specific values for the traditional rugosity parameters Rpk, Rk and Rvk. The movement of the abrasive tool takes place in both axial direction of a length L of the sleeve 1, in oscillating up and down movement, and in the rotational direction, by turning the tool inside the sleeve 1.

After carrying out the last step of the burnishing process, the inner surface 4 of the cylinder sleeve 1 of the present invention receives an additional treatment carried out by means of a magnetic surface finishing process that has the main objective of rounding the valleys and peaks of the rugosity structure of the inner surface 4, resulting from the burnishing process, and to reduce the peak density, parameters that cannot be achieved by means of the burnishing process.

In this additional magnetic surface finishing process, the cylinder sleeve 1 is positioned in a magnetic field created by a magnetic pole arranged inside the sleeve 1, close to its inner surface 4, comprising a space generated between the magnetic pole and the inner surface 4 of the sleeve 1, this space being filled with a magnetizable powder that has granulometry ranging from 4 to 300 micrometers, preferably from 6 to 200, preferably from 10 to 100 micrometers.

Upon starting the process, a magnetic field is formed, so that the magnetizable powder particles come into contact with the inner surface 4 of the sleeve 1, rounding the peaks and reducing the peak density of the surface 4. During the process, the magnetizable powder functions as an elastic tool, promoting wear of the peaks by friction with the powder, consequently rounding the peaks, so as to reduce abruptly the number of peaks per area unit of the inner surface 4.

In a preferred constructive embodiment, the inner surface 4 of the cylinder sleeve 1 exhibits a surface finish having rugosity defined by a valley-and-peak structure, said structure being traditionally specified by the parameters: Rpk—value of average rugosity of peaks that are above the minimum contact area of a profile, Rk—value of rugosity of the core of a profile, and Rvk value of the average rugosity of valleys that are below the contact area of a profile. The traditional rugosity prameters Rpk, Rk and Rvk can be seen in FIG. 2.

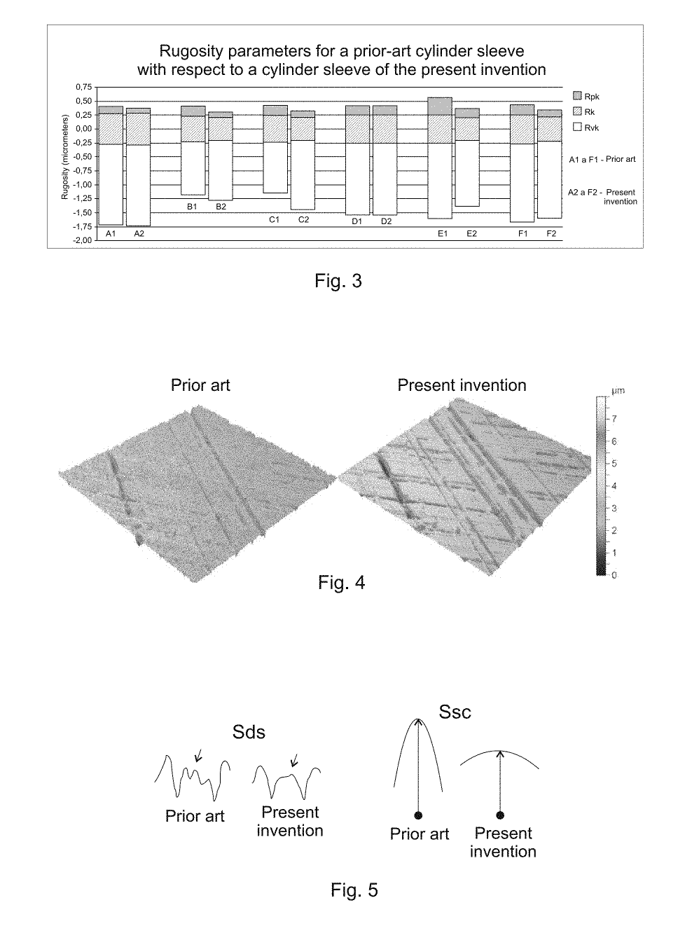

Thus, the cylinder sleeve 1 of the present invention initially comprises an inner surface 4 provided with rugosity defined by the traditional parameters Rpk, Rk and Rvk, so that the inner surface 4 will exhibit a minor reduction in the Rpk value, achieved by means of a conventional burnishing process, and said reduction may be observed in the graph in FIG. 3. It should be noted that, in its preferred embodiment, the burnishing process is carried out along the whole longitudinal/axial L length of the inner surface 4 of the cylinder sleeve 1, comprising burnishing angles that range from 20 to 70 degrees and from 122 to 160 degrees.

Besides the reduction of Rpk, the inner surface 4 of the cylinder sleeve 1 of the present invention exhibits a great variation for other surface rugosity parameters, which are not traditionally analyzed for definitions of surface finish.

The present invention has, as its main differential, the study of the parameters related to the valley-and-peak structure of the rugouse inner surface 4, chiefly the parameters related to the peak density of the surface (Sds), the mean radius of curvature of peaks (Ssc) and average height of peaks (Spk). FIG. 4 illustrates the inner surface 4 of a prior-art cylinder sleeve, which comprises a surface finish carried out by means of a conventional burnishing process, and the sleeve of the present invention, after application of the magnetic surface finishing process, so that one can observe the difference in the rugosity topography of the sleeves, when analyzed in the same position, measured by an optical microscope.

Analyzing the photos illustrated in FIG. 4, one can observe clearly the cylinder sleeve 1 of the present invention comprising an inner surface 4 with reduced peak density (Sds), that is, the number of peaks per area unit of the surface is reduced with respect to the inner surface illustrated in the prior art. Besides the reduction of the peak density (Sds), it is also possible to note that the mean radius of curvature of peaks (Ssc) is reduced, that it, the peaks and valleys of the surface are more rounded with respect to the initial surface. The reduction of the Sds and Ssc parameters can be observed in FIG. 5.

Table 1 below shows the result in the reduction of the density parameters (Sds) and mean radius of curvature (Ssc) of peaks of the inner surface 4 of the cylinder sleeve 1 of the present invention with respect to the prior art:

Percentage of reduction of the parameters Sds and Ssc (%)

| Density (Sds) | | | Mean radius of curvature (Ssc) | | |
|---|---|---|---|---|---|
| Prior art | Present invention | | Prior art | Present invention | |
| (1/mm²) | (1/mm²) | % | (1/mm) | (1/mm) | % |
| 48911 | 5862 | 88 | 388 | 101 | 74 |
| 53923 | 26189 | 51 | 408 | 94.3 | 77 |
| 56330 | 18559 | 67 | 438 | 89.1 | 80 |
| 50975 | 18156 | 64 | 404 | 89.6 | 78 |

One notes that the inner surface 4 of the sleeve 1 of the present invention achieved a reduction at least 51 to 88% in the peak density (Sds), with variation between 4,000 and 28,000 peaks per square millimeter (1/mm2); and a reduction of at least 74 to 80% in the mean radius of curvature of peaks (Ssc), with variation between 86 and 105 peaks per millimeter (1/mm).

The reduction of these parameters Sds and Scs, results in the reduction of the contact pressure of the inner surface 4 with its sliding parts (like a set of piston rings), since the areas of radius of peaks increase, thus raising the hydrodynamic lift brought about by the reduction of the peak density.

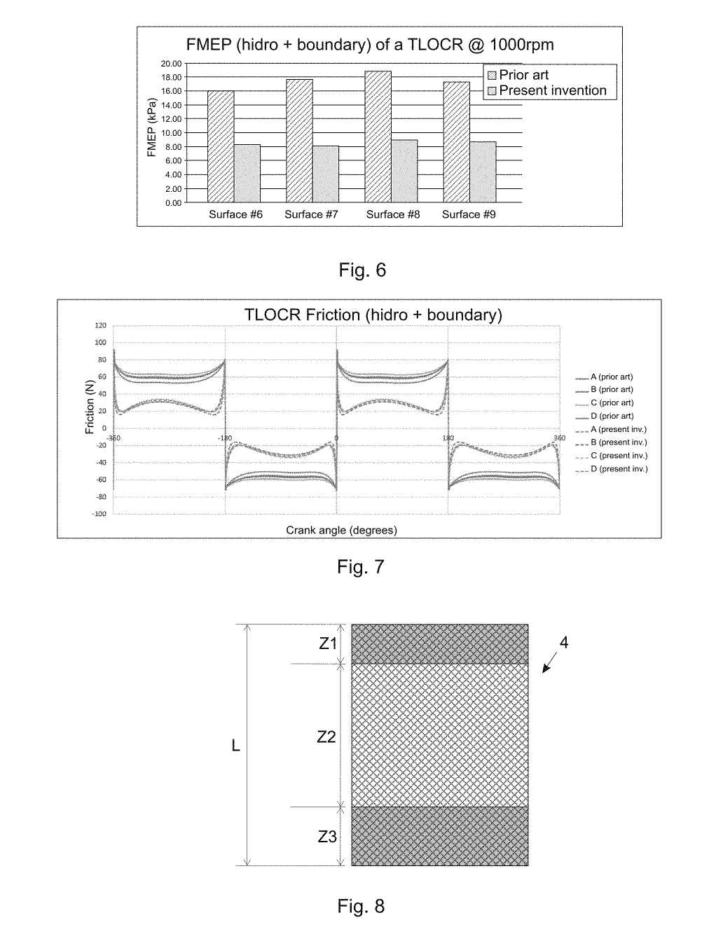

Besides the increase in the hydrodynamic lift of the inner surface 4, the reduction of the parameters Sds and Ssc also results in a reduction of about 0.50% in the consumption of fuel of the engine. The graph ion FIG. 6 and table 2 below show the results in the reduction of consumption of fuel, brought about by the reduction of the parameters Sds and Ssc.

FMEP (kPa) @1000 rpm

| | | | Estimate fo reduction in |
|---|---|---|---|
| Surfaces | Prior art | Present invention | the consumption of fuel |
| A | 16.00 | 8.32 | 0.38% |
| B | 17.73 | 8.09 | 0.48% |
| C | 18.62 | 8.95 | 0.48% |
| D | 17.41 | 8.74 | 0.43% |

It is noted that the friction means effective pressure (FMEP) was substantially reduced, achieving estimates of reduction in the consumption of fuel of up to 0.48%.

Moreover, the graph illustrated in FIG. 6, exhibits simulation friction curves indicating clearly the advantages achieved with respect to the reduction in the friction of the assembly internal surface 4 and piston rings, both at the piston reversion points (−360°, −180°, 0°, 180°, 300°), due to the reduction in the friction pressure, and at the stroke middle (−170°, −90°, 90°, 270°) due to the high hydrodynamic lift.

Therefore, the preferred embodiment of the cylinder sleeve 1 of the present invention comprises an inner surface 4 achieved by means of an initial burnishing process and a magnetic surface finishing process, the inner surface 4 exhibiting surface rugosity defined by a structure of rounded valleys and peaks, with reduction of at least 40% in the peak density (Sds) and reduction of at least 40% in the mean radius of curvature of peaks (Ssc), the rugosity parameters Sds and Ssc being established so that:

(I) the ratio between the peak density (Sds) and the mean radios of curvature of peaks (Ssc) is higher than 150 and lower than 400, thus:

150<Sds/Ssc<400;

(II) the ratio between the mean radius of curvature of peaks (Ssc) and the mean height of peaks (Spk) is lower than 1500, thus:

Ssc/Spk<1500.

In a second possible embodiment, the sleeve 1 of the present invention receives a surface finish carried out by means of the magnetic process described, in specific portions of its inner surface 4, which comprises a longitudinal/axial L length and is divided into at least two portions Z1, Z2 along its length L.

Preferably, the inner surface 4 is divided into three portions along its longitudinal length L, identified in FIG. 8, wherein:

(i) a first portion Z1, corresponding to the region approaching the limit of the displacement stroke of the piston facing the engine head (Pondo Morto Superior—PMS (upper dead center));

(ii) a second central portion Z2; and

(iii) a third portion Z3, corresponding to the region approaching the limit of the displacement stroke of the piston, but opposite (facing the engine crankshaft, Ponto Morto Inferior—PMI (lower dead end).

In this regard, the present application presents a cylinder sleeve 1 comprising an inner surface 4, each of the portions Z1, Z2, Z3 embracing lengths comprised in pre-established intervals, so that:

(I) the ratio between the sum of the lengths of the first portion Z1 and of the third portion Z3, and the longitudinal/axial L length of the cylinder sleeve 1 should be higher than 0.31 and lower than 0.58, thus:

0.31<(Z1+Z3)/L<0.58;

(II) the ratio between the lengths of the first portion Z1 and of the second portion Z2 should be higher than 0.15 and lower than 0.46, thus:

0.15<Z1/Z2<0.46.

Thus, the sleeve 1 of the present invention receives the magnetic surface finishing process in the regions Z1 and Z3 to prevent friction contact at the piston reversion points, or in the region Z2, in which the piston and piston rings reach highest speed.

In addition to the advantages described, the improvement in the inner surface 4 of the sleeve 1 of the present invention also enables the parameters, as tangential force exerted by a set of piston rings, to be adjusted by up to 0.6 N/mm (Newtons per millimeter), reducing the friction of the sleeve/ring assembly during operation of the engine.

Moreover, the cylinder sleeve 1 of the present invention exhibits, on its inner surface 4, a coating based on carbon or a plasma sprayed coating/thermal porous coating based on iron (>95% Fe) and iron alloys (chrome, tungsten, titanium, molybdenum, nickel, among others), in order to maximize the reduction in the friction of the sleeve/piston rings assembly.

In summary, the cylinder sleeve 1 of the present invention comprises an inner contact surface 4 with at least one piston ring, said inner surface 4 comprising a surface finish with rugosity that defines a valley-and-peak structure, particularly a structure in which the inner surface 4 comprises a reduced number of peaks per area unit, that is, a peak density (Sds) reduced by at least 40%, as well as rounded valleys and peaks, that ism, a mean radius of curvature (Ssc) reduced by at least 40%, guaranteeing an increase in the hydrodynamic lift of the inner surface 4 of the sleeve 1, particularly in the middle of the piston stroke, a region in which the piston and piston rings reach highest velocity, and reducing friction pressures of the internal surface/piston rings assembly, particularly at the piston reversion points, having, as a final result, a reduction of about 0.50% in the consumption of fuel of the internal combustion engine.

A preferred example of embodiment having been described, it should be understood that the scope of the present invention embraces other possible variations, being limited only by the contents of the accompanying claims, which include the possible equivalents.

1. A cylinder sleeve for an internal combustion engine, comprising:
a bore-through cylindrical body having an inner sliding surface having a surface finish with a rugosity defined by a valley-and-peak structures;
wherein the rugosity of the inner surface has:
a ratio between a peak density and a mean radius of curvature of peaks higher than 150 and lower than 400; and
a ratio between the mean radius of curvature of peaks and an average height of peaks lower than 1500.

2. The cylinder sleeve according to claim 1, wherein the peak density is from 4,000 to 28,000 peaks per square millimeter.

3. The cylinder sleeve according to claim 1, wherein the mean radius of curvature of peaks is from 86 to 105 peaks per millimeter.

4. The cylinder sleeve according to claim 1, wherein the rugosity is formed via a magnetic surface finishing process carried out after a burnishing process.

5. A magnetic surface finishing method for a cylinder sleeve of an internal combustion engine, comprising:
arranging a magnetic pole inside the cylinder sleeve, close to an inner surface of the cylinder sleeve;
filling an inside of the cylinder sleeve with a magnetizable powder;
creating a magnetic field inside the cylinder sleeve; and
wearing down a plurality of peaks of the inner surface via friction with the magnetizable powder.

6. The magnetic surface finishing method according to claim 5, wherein the magnetizable powder comprises has a granulometry from 4 to 300 micrometers.

7. The magnetic surface finishing method according to claim 5, further comprising carrying out a burnishing process on the inner surface of the cylinder sleeve prior to arranging the magnetic pole inside the cylinder sleeve.

8. The magnetic surface finishing method according to claim 6, wherein the magnetizable powder has a granulometry from 6 to 200 micrometers.

9. The magnetic surface finishing method according to claim 6, wherein the magnetizable powder has a granulometry from 10 to 100 micrometers.

10. The magnetic surface finishing method according to claim 5, wherein wearing down the plurality of peaks of the inner surface includes forming a surface finish on the inner surface having a rugosity with:
a ratio between a peak density and a mean radius of curvature of peaks greater than 150 and less than 400; and
a ratio between the mean radius of curvature of peaks and an average height of peaks lower than 1500.

11. The magnetic surface finishing method according to claim 5, wherein wearing down the plurality of peaks of the inner surface includes forming a peak density from 4,000 to 28,000 peaks per square millimeter.

12. The magnetic surface finishing method according to claim 5, wherein wearing down the plurality of peaks of the inner surface includes forming a mean radius of curvature of peaks from 86 to 105 peaks per millimeter.

13. The magnetic surface finishing method according to claim 12, wherein wearing down the plurality of peaks of the inner surface further includes forming a peak density from 4,000 to 28,000 peaks per square millimeter.

14. The magnetic surface finishing method according to claim 13, wherein wearing down the plurality of peaks of the inner surface further includes forming a surface finish on the inner surface having a rugosity with:
a ratio of the peak density to the mean radius of curvature of peaks between 150 and 400; and
a ratio of the mean radius of curvature of peaks to an average height of peaks lower than 1500.

15. The cylinder sleeve according to claim 1, wherein the inner surface is a burnished, magnetic finished inner sliding surface.

16. The cylinder sleeve according to claim 15, wherein the peak density is from 4,000 to 28,000 peaks per square millimeter.

17. The cylinder sleeve according to claim 15, wherein the mean radius of curvature of peaks is from 86 to 105 peaks per millimeter.

18. A cylinder sleeve for an internal combustion engine, comprising a bore-through cylindrical body having an inner sliding surface, wherein:
the inner sliding surface has a surface finish and a rugosity;
the rugosity is defined by a valley-and-peak structure including a plurality of peaks and a plurality of valleys; and
the rugosity of the inner surface has:
a ratio of a density of the plurality of peaks to a mean radius of curvature of the plurality of peaks between 150 and 400; and
a ratio of the mean radius of curvature to an average height of the plurality of peaks lower than 1500.

19. The cylinder sleeve according to claim 18, wherein the inner surface is a burnished, magnetic finished inner sliding surface.

20. The cylinder sleeve according to claim 19, wherein:
the peak density is from 4,000 to 28,000 peaks per square millimeter; and
the mean radius of curvature of peaks is from 86 to 105 peaks per millimeter.
